(19) United States
(12) Patent Application Publication
(10) Pub. No.: US 2013/0276301 A1
(43) Pub. Date: Oct. 24, 2013

(54) METHOD FOR ADJUSTING POSITIONS OF LEDS OF LED LIGHT BAR

(71) Applicant: CHIH-CHEN LAI, Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/545,914

(22) Filed: Jul. 10, 2012

(30) Foreign Application Priority Data
Apr. 18, 2012 (TW) 101113782

(51) Int. Cl. H01R 43/00

(52) U.S. Cl. 29/825

(57) ABSTRACT

A method for adjusting positions of LEDs of an LED light bar includes following steps: providing a circuit board with a plurality of LEDs arranged thereon; measuring offsets X0 between the LEDs and a base line; providing a first flat plate and a second flat plate paralleled to the base line and contacted with two opposite sides of the circuit board; and measuring a distance X1 between the first flat plate and the base line, and a distance X2 between the second flat plate and the base line. Therefore, offsets A between the LEDs and a central axis of a space between the first and second flat plates can be obtained by the following equation: A=X0−(X1−X2)/2. The offsets A are used to adjust the positions of the LEDs to be actually mounted on the circuit board.

### BACKGROUND

1. Technical Field

The disclosure generally relates to a method for adjusting positions of LEDs of an LED light bar, and particularly to a method for adjusting positions of LEDs of an LED bar which is used as a light source of a back light module.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices. LED light bars are now more and more popular in replacing cold-cathode fluorescent lamps (CCFLs) as the light source for a back light module. A light bar consists of a rectangular circuit board and a plurality of LEDs mounted on the circuit board. The light bar is put into a groove defined by a holder with tops of the LEDs facing upwardly. An end of a light guide is inserted into the groove of the holder with an edge of the light guide facing the tops of the LEDs. Light generated by the LEDs emits upwardly from the tops of the LEDs to enter the light guide.

In assembly of the LED light bar, it needs to detect positions of the LEDs to be mounted on the circuit board. Generally, a straight line passing through middles of two ends of the circuit board acts as a base line, and an offset between each of the LEDs and the base line is measured by an optical measuring device. If the offset exceeds an allowable limit, an adjustment of the position of the related LED to be mounted on the circuit board shall be proceeded. However, if the circuit board is not perfectly rectangular, the base line passing through the middles of two ends of the circuit board will deviate from an actual central axis of the groove of the holder for accommodating the LED light bar, whereby the measured offset based on the base line of the circuit board is inaccurate to enable the LEDs of the LED light bar to be aligned with the actual central axis of the groove of the holder. Accordingly, optical axes of the LEDs will deviate from a central line of the edge of the light guide. Thus, the light generated the LEDs can not entirely enter the light guide to be fully utilized and the back light module has a reduced lighting efficiency.

What is needed, therefore, is a method for adjusting positions of LEDs of an LED light bar to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a top view showing a method for adjusting positions of LEDs of an LED light bar in accordance with a first embodiment of the present disclosure.

FIG. 2 is a top view showing a method for adjusting positions of LEDs of an LED light bar in accordance with a second embodiment of the present disclosure.

FIG. 3 is a top view showing a method for adjusting positions of LEDs of an LED light bar in accordance with a third embodiment of the present disclosure.

### DETAILED DESCRIPTION

Embodiments of aligning an LED light bar will now be described in detail below and with reference to the drawings.

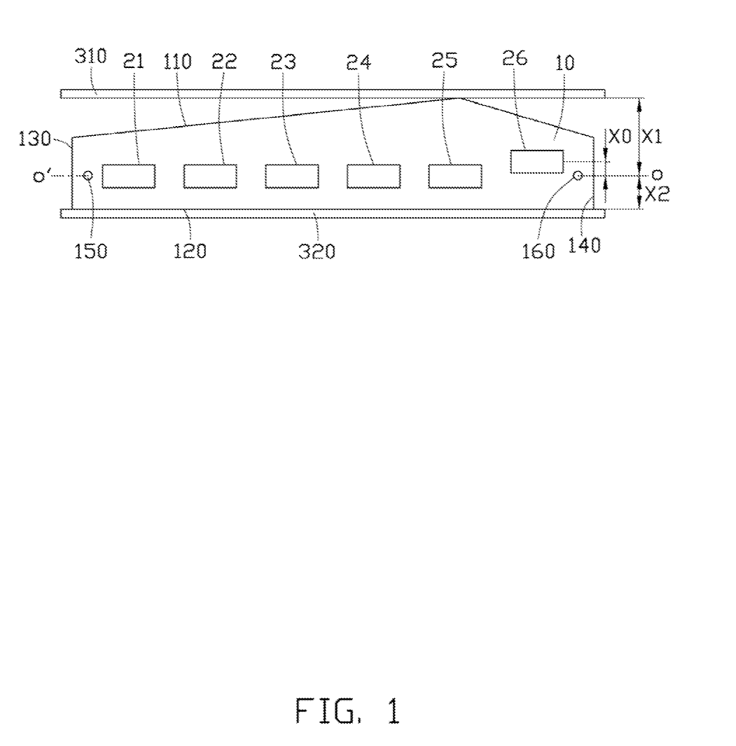

Referring to FIG. 1, a method for adjusting positions of LEDs of an LED light bar includes the following steps.

A circuit board 10 is firstly provided. The circuit board 10 includes a first side 110, a second side 120 opposite to the first side 110, a third side 130 and a fourth side 140 opposite to the third side 130. The third side 130 and the fourth side 140 are connected between the first side 110 and the second side 120. In this embodiment, the first side 110 is protruding outwardly from a part of the circuit board 10 near the fourth side 140, and the second side 120 is formed as a straight line. The protruding degree of the first side 110 is exaggerated for illustration. The circuit board 10 is elongated, so that lengths of the first side 110 and the second side 120 are larger than lengths of the third side 130 and the fourth side 140. A plurality of LEDs or LED footprints 21-26 are arranged on the circuit board 10 along the lengthwise direction of the circuit board 10.

A base line OO′ is provided along the lengthwise direction of the circuit board 10, and offsets between the LEDs 21-26 and the base line OO′ are then measured by an optical measuring device. In this embodiment, centers of the LEDs 21-25 are aligned with the base line OO′; therefore, the offsets between the LEDs 21-25 and the base line OO′ are zero. Center of the LED 26 is deviated from the base line OO′; therefore, the offset between the LED 26 and the base line OO′ is X0. Preferably, a first aligning point 150 and a second aligning point 160 are defined in the circuit board 10 and the base line OO′ passes through the first aligning point 150 and the second aligning point 160. In this embodiment, the second side 120 is parallel to the base line OO′. The first aligning point 150 is adjacent to the third side 130 of the circuit board 10 and located in a middle portion of the third side 130. Similarly, the second aligning point 160 is adjacent to the fourth side 140 of the circuit board 10 and located in a middle portion of the fourth side 140. The LEDs 21-26 are arranged between the first aligning point 150 and the second aligning point 160.

After that, a first flat plate 310 and a second flat plate 320 are provided. A distance between the first and second flat plates 310, 320 is equal to a width of a groove of a holder of a backlight module in which the LED light bar is to be inserted. The first flat plate 310 and the second flat plate 320 are parallel to the base line OO′. The first flat plate 310 is in contact with an apex of the first side 110, and the second flat plate 320 is in conformable contact with the second side 120. In this embodiment, the first side 110 is protruding outwardly from a part of the circuit board 10 near the fourth side 140, and the first flat plate 310 is in contact with a point of the first side 110 farthest to the base line OO′.

A distance between the first flat plate 310 and the base line OO′, and a distance between the second flat plate 320 and the base line OO′ are then measured by the optical measuring device. In this embodiment, the distance between the first flat plate 310 and the base line OO′ is measured as X1, and the distance between the second flat plate 320 and the base line OO′ is measured as X2. Therefore, offsets A between the LEDs 21-26 and a central axis of the space between the two flat plates 310, 320 can be obtained by the following eqution: A=X0−(X1−X2)/2, wherein X0 represents offsets between the LEDs 21-26 and the base line OO′; X1 represents a distance between the first flat plate 310 and the base line OO′; X2 represents a distance between the second flat plate 320 and the base line OO′. For example, the offsets between the LEDs 21-25 and the base line OO′ are zero; therefore, the offsets between the LEDs 21-25 and the central axis of the space between the flat plates 310, 320 are (X1−X2)/2. The offset between the LED 26 and the base line OO′ is X0; therefore, the offset between the LED 26 and the central axis of the space between the two flat plates 310, 320 is X0−(X1−X2)/2. Should X0 equal to (X1−X2)/2, the position of the LED 26 to be actually mounted on the circuit board 10 does not need to be adjusted, and the positions of the LEDs 21-25 to be actually mounted on the circuit board 10 should be moved a distance of (X1−X2)/2 toward the first flat plate 310. According to the present disclosure, X0 is positive if X0 is measured from the base line OO′ toward the first side 110 and X0 is negative if X0 is measured from the base line OO′ toward the second side 120. If A is minus the corresponding LED to be actually mounted on the circuit board 10 should be moved a distance of absolute value of A from its position shown in the drawings toward the first side 110 of the circuit board 10, and if A is positive the corresponding LED to be actually mounted on the circuit board 10 should be moved a distance of A from its position shown in the drawings toward the second side 120 of the circuit board 10.

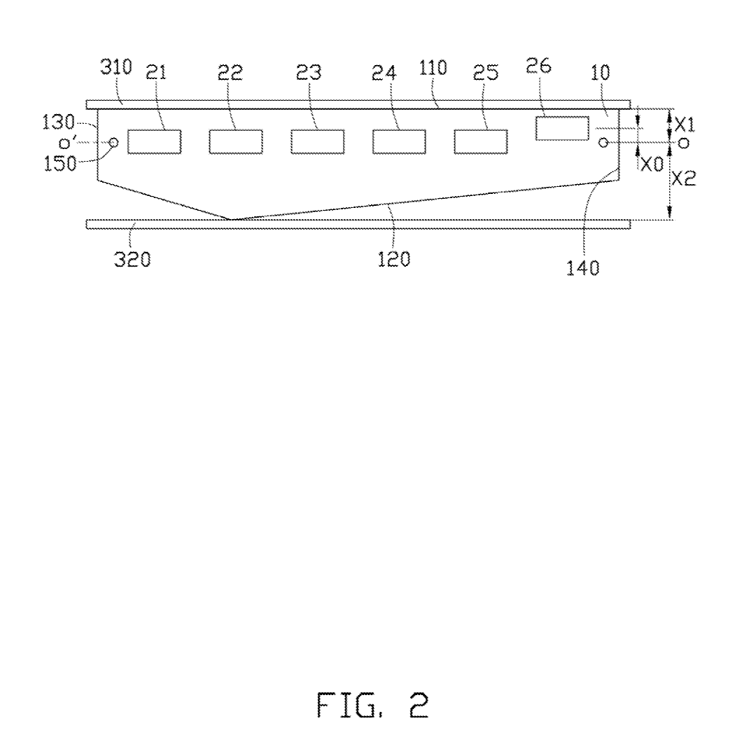

Alternatively, the circuit board 10 can be other structures. Referring to FIG. 2, a circuit board 10 in accordance with a second embodiment is provided. The circuit board 10 includes a first side 110 and a second side 120 opposite to the first side 110. Different from the first embodiment, the first side 110 is a straight line, and the second side 120 is protruding outwardly from a part of the circuit board 10 near the third side 130. Therefore, the second flat plate 320 is in contact with a point of the second side 120 farthest to the base line OO′. In this embodiment, the actual positions of the LEDs 21-25 to be mounted on the circuit board 10 should be moved from what they are shown in FIG. 2 a distance of (X2−X1)/2 toward the second flat plate 320. Meanwhile, the actual position of the LED 26 to be mounted on the circuit board 10 should be moved from what it is shown in FIG. 2 a distance of X0+(X2−X1)/2 toward the second flat plate 320.

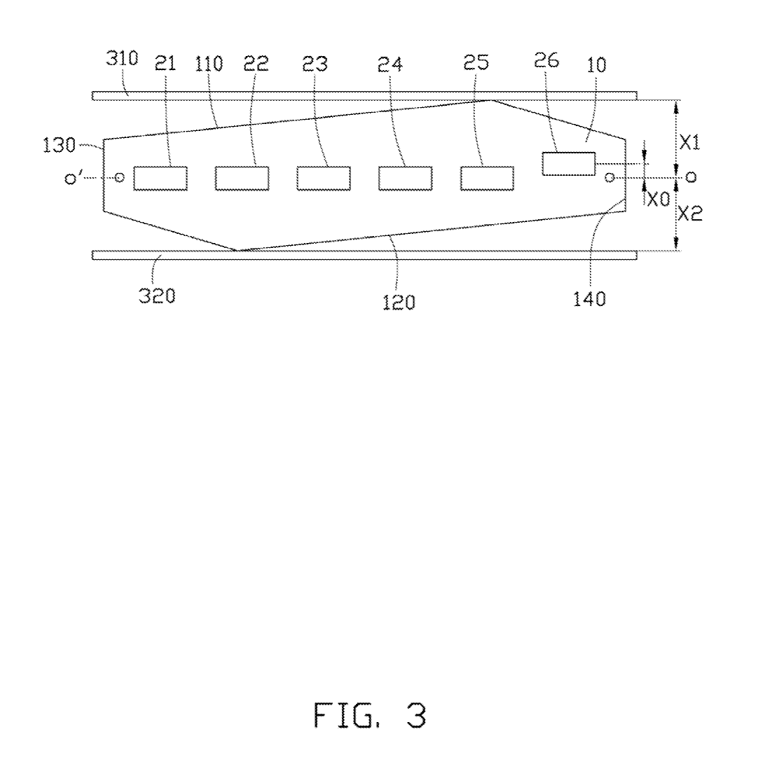

Referring to FIG. 3, a circuit board 10 in accordance with a third embodiment is provided. The circuit board 10 includes a first side 110 and a second side 120 opposite to the first side 110. The first side 110 and the second side 120 are protruding outwardly from a part of the circuit board 10 near the fourth side 140 and a part of the circuit board 10 near the third side 130. Therefore, the first flat plate 310 is in contact with a point of the first side 110 farthest to the base line OO′, and the second flat plate 320 is in contact with a point of the second side 120 farthest to the base line OO′. Should X1 equal X2, the positions of the LEDs 21-25 to be actually mounted on the circuit board 10 do not need to be adjusted, meanwhile the position of the LED 26 to be actually mounted on the circuit board should be moved a distance of X0 toward the second flat plate 320.

In the above method for adjusting positions of the LED light bar, a distance between the first flat plate 310 and the base line OO′, and a distance between the second flat plate 320 and the base line OO′ can be measured. Therefore, according to the offsets between the LEDs 21-26 and the base line OO′, the offsets between the LEDs 21-26 and the central axis of the space between the two flat plates 310, 320 can be calculated by X0−(X1−X2)/2. Therefore, the positions of the LEDs 21-26 to be actually mounted on the circuit board 10 can be easily adjusted whereby centers of the LEDs 21-26 can be accurately aligned with the central axis of the groove of the holder when the LED light bar is put in the groove.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for adjusting positions of LEDs (light emitting diodes) of an LED light bar, comprising following steps:
providing a rectangular circuit board with a plurality of LEDs arranged on the circuit board and along a lengthwise direction of the circuit board, the circuit board having opposite first and second sides and opposite third and fourth sides wherein the first and second sides are longer than the third and fourth sides, the circuit board having a base line on the circuit board and along the lengthwise direction of the circuit board, the base line extending through a middle of the third side and a middle of the fourth side, and measuring an offset X0 between each of the LEDs and the base line by an optical measuring device;
providing a first flat plate and a second flat plate, the first flat plate and the second flat plate being parallel to the base line and contacted with the opposite first and second sides of the circuit board; and
measuring a distance between the first flat plate and the base line by the optical measuring device, and measuring a distance between the second flat plate and the base line by the optical measuring device, an offset A between each of the LEDs and a central axis of a space between the first and second plates being obtained by following equation: A=X0−(X1−X2)/2, wherein X0 represents the offset between a corresponding LED and the base line, X1 represents a distance between the first flat plate and the base line, and X2 represents a distance between the second flat plate and the base line, wherein X0 is positive if X0 is measured from the base line toward the first side and X0 is negative if X0 is measured from the base line toward the second side and if A is minus the corresponding LED to be actually mounted on the circuit board should be moved a distance of absolute value of A toward the first side of the circuit board and if A is positive the corresponding LED to be actually mounted on the circuit board should be moved a distance of A toward the second side of the circuit board, whereby all of the LEDs are aligned with the central axis of the space between the first and second plates.

2. The method of claim 2, wherein the circuit board comprises a first aligning point and a second aligning point, the base line passes through the first aligning point and the second aligning point.

3. The method of claim 2, wherein the first aligning point is adjacent to the third side of the circuit board, and the second aligning point is adjacent to the fourth side of the circuit board, the LEDs are arranged between the first aligning point and the second aligning point.

4. The method of claim 1, wherein the first side is protruding outwardly, and the second side is a straight line, the first flat plate is in contact with a point of the first side farthest to the base line.

5. The method of claim 1, wherein the first side is a straight line and the second side is protruding outwardly, the second flat plate is in contact with a point of the second side farthest to the base line.

6. The method of claim 1, wherein the first side and the second side are protruding outwardly, the first flat plate is in contact with a point of the first side farthest to the base line, and the second flat plate is in contact with a point of the second side farthest to the base line.

7. The method of claim 1, wherein a distance between the first and second flat plates equals to a width of a groove of a holder of a backlight module in which the LED light bar is to be inserted.

8. A method for adjusting positions of LEDs (light emitting diodes) of an LED light bar, comprising following steps:
providing a rectangular circuit board with a plurality of LED footprints arranged on the circuit board and along a lengthwise direction of the circuit board, the circuit board having opposite first and second sides and opposite third and fourth sides wherein the first and second sides are longer than the third and fourth sides, the circuit board having a base line on the circuit board and along the lengthwise direction of the circuit board, the base line extending through a middle of the third side and a middle of the fourth side, and measuring an offset X0 between each of the LED footprints and the base line by an optical measuring device;
providing a first flat plate and a second flat plate, the first flat plate and the second flat plate being parallel to the base line and contacted with the opposite first and second sides of the circuit board; and
measuring a distance between the first flat plate and the base line by the optical measuring device, and measuring a distance between the second flat plate and the base line by the optical measuring device, an offset A between each of the LED footprints and a central axis of a space between the first and second plates being obtained by following equation: A=X0−(X1−X2)/2, wherein X0 represents the offset between a corresponding LED footprint and the base line, X1 represents a distance between the first flat plate and the base line, and X2 represents a distance between the second flat plate and the base line, wherein X0 is positive if X0 is measured from the base line toward the first side and X0 is negative if X0 is measured from the base line toward the second side and if A is minus an LED corresponding to the corresponding LED footprint to be actually mounted on the circuit board should be moved a distance of absolute value of A toward the first side of the circuit board and if A is positive the LED to be actually mounted on the circuit board should be moved a distance of A toward the second side of the circuit board, whereby all of the LEDs actually mounted on the circuit board are aligned with the central axis of the space between the first and second plates.

9. The method of claim 8, wherein a distance between the first and second flat plates equals to a width of a groove of a holder of a backlight module in which the LED light bar is to be inserted.
